(19) United States
(12) Patent Application Publication
(10) Pub. No.: US 2026/0330654 A1
(43) Pub. Date: Oct. 22, 2026

(54) IMAGE TRACKING APPARATUS, IMAGE TRACKING METHOD, AND STORAGE MEDIUM

(71) Applicant: CANON KABUSHIKI KAISHA, Tokyo (JP)

(72) Inventor: Yoshiki OHNO, Kanagawa (JP)

(21) Appl. No.: 19/630,597

(22) Filed: Mar. 27, 2026

(30) Foreign Application Priority Data
Apr. 22, 2025 (JP) 2025-070438

(51) Int. Cl. G06T 7/246; G06T 3/40

(52) U.S. Cl. CPC G06T 7/248; G06T 3/40; G06T 2207/10016; G06T 2207/20104; G06T 2207/30196

(57) ABSTRACT

An image tracking apparatus is an apparatus that acquires time-series continuous input images and tracks a subject in the images, and comprises a clipping reference region determination unit that determines a clipping reference region from an image; an image clipping unit that clips, from the image, a plurality of images of regions each having a different size and each including the clipping reference region that has been determined by the clipping reference region determination unit; a tracking unit that performs tracking processing for a subject in each of the images that have been clipped by the image clipping unit based on features of the subject; and a tracking result integration unit that calculates a tracking reliability for a plurality of output tracking results and integrates tracking results corresponding to images of different clipping regions based on the tracking reliability.

### BACKGROUND

### Field of the Technology

The present disclosure relates to an image tracking apparatus, and more particularly to an image tracking apparatus that is suitable for improving tracking accuracy by achieving both the ease of finding a subject and the suppression of erroneous tracking, using tracking results for appropriate clipping ranges according to states when tracking a region of a specific subject in time-series continuous images.

### Description of the Related Art

Technologies for detecting and tracking specific subjects within time-series continuous images are widely utilized across various fields, including in monitoring cameras, sports video analysis, autofocus (AF) control, and augmented reality (AR).

Tracking refers to detecting a desired subject within an image and continuously tracking the same subject across successive frames. Generally, tracking processing comprises a series of steps: (1) detecting the target in an initial frame, (2) estimating the position of the target across successive frames, and (3) updating the tracking results.

Conventional image tracking technologies include template‑matching methods, optical‑flow‑based methods that use luminance or color information, and machine‑learning‑based methods that are represented by deep neural networks.

Tracking using template matching is a method in which a previously acquired image of the subject (template) is compared with partial regions of an input image to track the region with the highest similarity. Tracking based on optical flow is a method that estimates the motion of a target object by analyzing temporal changes in pixel values.

Regarding tracking technology that utilizes machine learning, an example is disclosed in L. Bertinetto et al., “Fully-Convolutional Siamese Networks for Object Tracking,” ECCV 2016, Jun. 30, 2016 (URL: https://arxiv.org/abs/1606.09549). The document by Bertinetto describes a technology for identifying a position of a tracked object in an image by inputting an image in which the tracked object appears and an image in which the tracked object will be searched for into a convolutional neural network (CNN), and calculating a correlation between feature quantities obtained therefrom.

In conventional tracking processing, technologies are known in which a portion of an image is clipped and processed, thereby reducing computational load and preventing erroneous tracking. Technologies related to such clipping are disclosed, for example, in Japanese Patent Application Laid-Open No. 2010-11441 and Japanese Patent Application Laid-Open No. 2021-141421.

Japanese Patent Application Laid-Open No. 2010-11441 describes a technology in which a region containing a tracked object is clipped, the reliability of the tracking processing is evaluated, and a size of the clipped region is changed according to the reliability.

Additionally, Japanese Patent Application Laid-Open No. 2021-141421 describes a technology in which, when setting a clipping region for detecting a subject, a degree of transition is calculated that determines whether to continue following a detected main subject or to switch to another subject, and the clipping region is set based on the calculated degree of transition.

In the technology disclosed in the Bertinetto document of the conventional art, there is a possibility of erroneous tracking in a case in which an object or a background similar to a subject is present in an image.

In Japanese Patent Application Laid-Open No. 2010-011441 and Japanese Patent Application Laid-Open No. 2021-141421, technologies are adopted in which a portion of an image is clipped and processed during tracking, thereby reducing computational load and preventing erroneous tracking.

However, in such methods, setting the clip size presents a significant trade-off. That is, in a case in which the clip range is too narrow, extraneous background and similar objects can be excluded, thereby suppressing erroneous tracking. However, if the subject moves significantly, it may fall outside the frame, increasing the risk of losing the tracked object. In contrast, in a case in which the clipping range is excessively wide, tracking can be easily maintained even in a case in which the subject moves, although the influence of the background tends to increase, thereby increasing the possibility of erroneously tracking another similar object.

Although Japanese Patent Application Laid-Open No. 2010-011441 discloses a method for coping with scale changes for a tracked object, the processing is assumed to be performed only at a single scale, and therefore, in a case in which a large scale change occurs, erroneous tracking may occur. Although Japanese Patent Application Laid-Open No. 2021-141421 proposes a technique for dynamically changing a clipping range, the technique is not designed to sufficiently cope with abrupt scale changes or situations in which a tracked object crosses another subject.

Thus, since the clipping range is statically set in conventional technologies, it is difficult to adapt to different circumstances, and appropriate tracking cannot be maintained in a case in which a tracked object crosses another subject.

Furthermore, there is a risk of erroneous tracking due to scale changes in the subject. That is, when the tracked object moves closer to or farther away from the camera, appropriate matching cannot be performed using a single-scale template. In particular, in conventional technologies that dynamically change clip magnification, scale inconsistency is likely to occur because the scale during template registration differs from the scale during tracking.

An object of the present disclosure is to provide an image tracking apparatus capable of improving tracking accuracy by achieving both ease of finding a subject and suppression of erroneous tracking, using tracking results of appropriate clipping ranges according to states.

### SUMMARY

The configuration of an image tracking apparatus according to the present disclosure is preferably an image tracking apparatus that acquires time-series continuous input images and tracks a subject in the images, the image tracking apparatus comprising: a clipping reference region determination unit that determines a clipping reference region from an image; an image clipping unit that clips, from the image, a plurality of images of regions, each having a different size and including the clipping reference region determined by the clipping reference region determination unit; a tracking unit that performs tracking processing for a subject in each of the images that have been clipped by the image clipping unit based on features of the subject; and a tracking result integration unit that calculates a tracking reliability for a plurality of output tracking results and integrates tracking results corresponding to images of different clipping regions based on the tracking reliability.

Features of the present disclosure will become apparent from the following description of embodiments with reference to the attached drawings. The following description of embodiments are described by way of example.

### BRIEF DESCRIPTION OF THE DRAWINGS

FIG. 1 is a hardware configuration diagram of an image tracking apparatus according to a first embodiment.

FIG. 2 is a functional configuration diagram of the image tracking apparatus according to the first embodiment.

FIG. 3 is a flowchart illustrating the overall subject tracking processing performed by the image tracking apparatus in the first embodiment.

FIG. 4 is a flowchart illustrating details of tracking result integration processing.

FIG. 5A is a diagram explaining an image related to tracking (Part 1).

FIG. 5B is a diagram explaining an image related to tracking (Part 2).

FIG. 5C is a diagram explaining an image related to tracking (Part 3).

FIG. 5D is a diagram explaining an image related to tracking (Part 4).

FIG. 5E is a diagram explaining an image related to tracking (Part 5).

FIG. 5F is a diagram explaining an image related to tracking (Part 6).

FIG. 5G is a diagram explaining an image related to tracking (Part 7).

FIG. 5H is a diagram explaining an image related to tracking (Part 8).

FIG. 5I is a diagram explaining an image related to tracking (Part 9).

FIG. 6A is a diagram explaining the influence of image resizing (Part 1).

FIG. 6B is a diagram explaining the influence of image resizing (Part 2).

FIG. 6C is a diagram explaining the influence of image resizing (Part 3).

FIG. 7 is a functional configuration diagram of an image tracking apparatus according to a second embodiment.

FIG. 8 is a flowchart illustrating overall subject‑tracking processing performed by the image tracking apparatus in the second embodiment.

FIG. 9 is a functional configuration diagram of an image tracking apparatus according to a third embodiment.

FIG. 10 is a flowchart illustrating overall subject‑tracking processing performed by the image tracking apparatus in the third embodiment.

FIG. 11 is a functional configuration diagram of an image tracking apparatus according to a fourth embodiment.

FIG. 12 is a flowchart illustrating overall subject‑tracking processing performed by the image tracking apparatus in the fourth embodiment.

### DESCRIPTION OF THE EMBODIMENTS

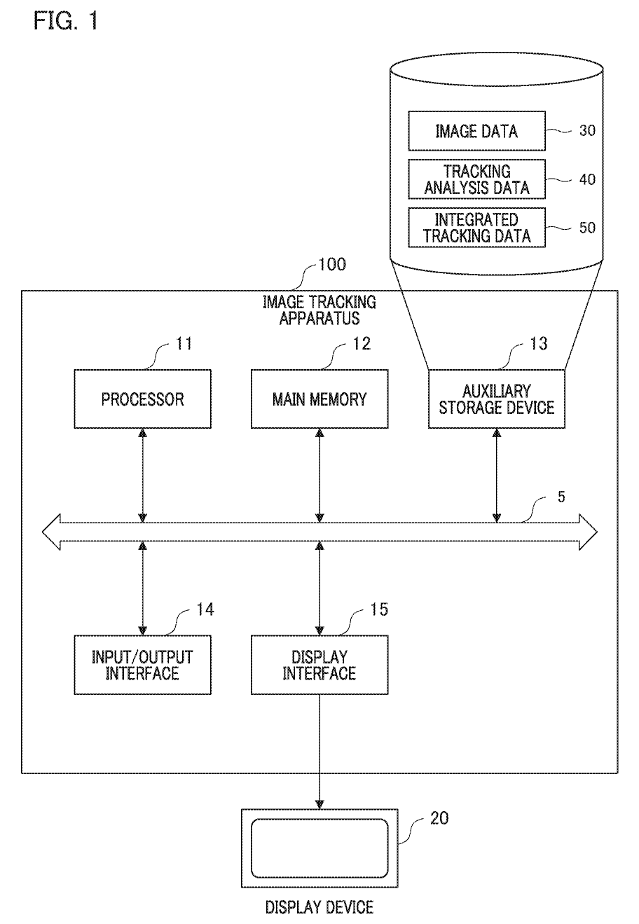

Embodiments of the present disclosure will be explained below with reference to FIGS. 1 to 12. An image tracking apparatus according to the present disclosure receives time‑series continuous images as input and tracks a subject to be tracked within the images. In the following embodiments, an example is explained in which the subject is a person (human figure) and the entire body of the person is tracked. However, the portion to be tracked may instead be the upper body or the head, and the subject may be an animal or a vehicle. That is, any object may be used as the object to be tracked, provided that feature quantities of the object are capturable as image features.

### First Embodiment

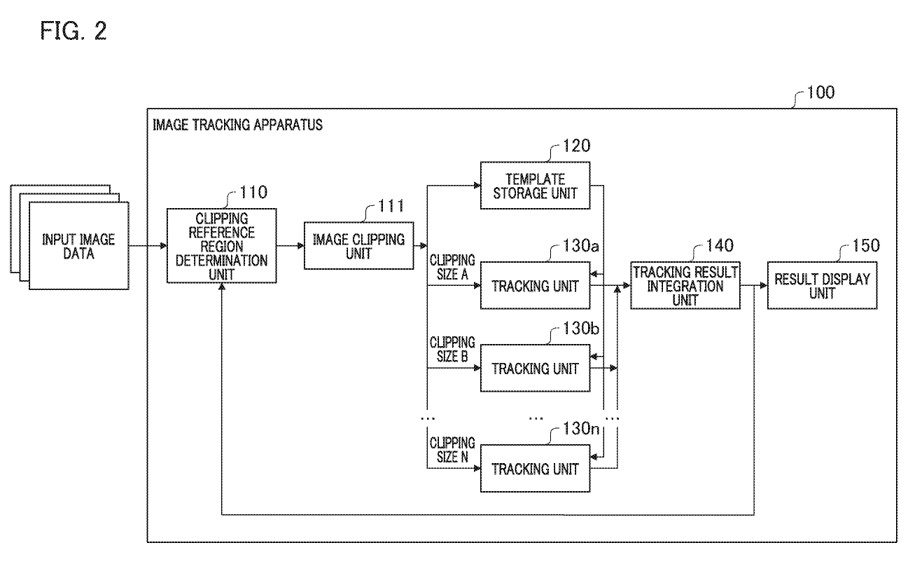

The first embodiment of the present disclosure will be explained below with reference to FIGS. 1 to 5I. First, the configuration of the image tracking apparatus according to the first embodiment will be explained with reference to FIGS. 1 and 2. FIG. 1 is a hardware configuration diagram of the image tracking apparatus according to the first embodiment. FIG. 2 is a functional configuration diagram of the image tracking apparatus according to the first embodiment.

As shown in FIG. 1, an image tracking apparatus 100 according to the present embodiment is configured such that a processor 11, a main memory 12, an auxiliary storage device 13, an input/output interface 14, and a display interface 15 are connected to one another via a bus 5.

The processor 11, also referred to as a Central Processing Unit (CPU), executes computer programs that have been loaded onto the main memory 12 and controls the respective components of the image tracking apparatus 100. The main memory 12 is a volatile semiconductor device, such as a RAM, that stores computer programs to be executed by the processor 11 and temporary data. The auxiliary storage device 13 is a large-capacity non-volatile storage device, such as a Hard Disk Drive (HDD), a Solid State Drive (SSD), or a CD-ROM. In the image tracking apparatus 100, the processor 11 loads computer programs that have been installed on the auxiliary storage device 13 onto the main memory 12. The functions of the respective components are realized by the processor 11 executing the programs that have been loaded onto the main memory 12. The input/output interface 14 is an interface device for connecting to external input/output devices, such as an interface circuit based on the Universal Serial Bus (USB) standard. Although not illustrated, examples of input/output devices include input devices such as a keyboard and a mouse, and output devices such as a printer. The display interface 15 is an interface device for connecting to a display device 20, such as a graphics board.

Additionally, the auxiliary storage device 13 stores, as data, image data 30, tracking analysis data 40, and integrated tracking data 50. Note that details of each type of data will be explained below.

As shown in FIG. 2, the image tracking apparatus 100 includes, as a functional configuration, a clipping reference region determination unit 110, an image clipping unit 111, a template storage unit 120, tracking units 130 (denoted as 130a to 130n in the figure), a tracking result integration unit 140, and a result display unit 150.

First, input image data is input to the image tracking apparatus 100. The input image data is time‑series continuous image data that includes a subject to be tracked.

The clipping reference region determination unit 110 determines a region that serves as a reference for image clipping. For example, in the case of an initial frame for tracking, one region to be tracked is selected from among the results of human figure detection that has been performed on the entire image, and this region is set as the clipping reference region. As for the selection method, the user may directly specify the region via a user interface, in the case of a camera, a detection result that is the closest to a preset AF‑priority region may be automatically selected; and an image feature quantity may be input, and an image region similar to that feature quantity may be used as the clipping reference region. Additionally, for example, in the case of subsequent frames of an initial tracking frame, a tracking result for a previous image, that is, an output of the tracking result integration unit 140, is set as the clipping reference region (details will be described below). At this time, the output of the tracking result integration unit 140 may be used directly as the clipping reference region, or the position of the tracked object in the next frame may be predicted based on that output, and the predicted region may be set as the clipping reference region.

The image clipping unit 111 clips a plurality of partial regions of different sizes from the image 101. At this time, the center of each clipped region is aligned with the center of the reference region determined by the clipping reference region determination unit 110.

In the initial tracking frame, the template storage unit 120 acquires and stores a tracking template from the images that have been generated by the image clipping unit 111. A template represents the features of the tracked object and is data that is used to identify the target in the subsequent frames. The templates are acquired from each of the images that have been clipped as tracked objects by the image clipping unit 111, and are stored individually. That is, the same number of templates are stored as the number of images that have been clipped as tracked objects by the image clipping unit 111. The information stored as a template may be an image itself in a case in which tracking is performed by template matching and the like, and may also be image feature quantities that have been obtained by a CNN in a case in which tracking is performed using, for example, a learning model employing a CNN.

In subsequent frames for an initial tracking frame, the tracking units 130 (denoted as 130a to 130n in the drawings) perform tracking processing using, as input, images generated by the image clipping unit 111. For example, the tracking unit 130 searches for an image of an object that is similar to a template that is stored in the template storage unit 120, and outputs candidates for the region in which the object appears. At this time, the tracking processing is executed for each of a plurality of images that have been clipped by the image clipping unit 111, and a result is output for each image.

The tracking result integration unit 140 integrates the results of the respective tracking units and finally determines a tracking result for the current frame. Details of the specific integration procedures will be described below.

The result display unit 150 displays a result of the tracking result integration unit 140 to a user. For example, the result display unit 150 causes a display device of the image tracking apparatus to display a region corresponding to a tracking result by enclosing the region with a rectangular frame, thereby presenting the result to a user.

Next, a data structure that is used in the image tracking apparatus according to the present embodiment will be explained.

As shown in FIG. 1, the image tracking apparatus 100 holds image data 30, tracking analysis data 40, and the integrated tracking data 50.

The image data 30 is moving image data including a tracked object. The image data 30 includes input image data Iₜ and clipped image data Cₜ ⁽ⁿ⁾.

The input image data Iₜ is image data including full-size image information at each time t in a time-series of continuous frames. The clipped image data Cₜ ⁽ⁿ⁾ is a portion of the input image data Iₜ at each time t that serves as the target of tracking processing, and it is clipped in n different ranges (sizes) and used as input for tracking. For example, a narrow range clipped image data Cₜ ⁽¹⁾ is used to improve tracking accuracy, while a wide range clipped image data Cₜ ⁽²⁾ isused to handle situations in which the tracking subject crosses another subject or is temporarily lost.

The tracking analysis data 40 is data used for analysis in tracking a subject. The tracking analysis data 40 includes template data T₀, tracking candidate data Pₜ ⁽ⁿ⁾, tracking reliability Sₜ ⁽ⁿ⁾, clip history data Hₜ, and crossing determination information Dₜ. The template data T₀ is data for an initial template of a tracked object, the initial template including feature information for a subject that is registered in a first frame. The tracking candidate data Pₜ ⁽ⁿ⁾ is coordinate information (such as a bounding box) for a subject candidate in the frame at each time t for each clipped region. The tracking reliability Sₜ ⁽ⁿ⁾ is a score indicating the reliability of the tracking, such as a similarity score or a probability value in the frames for each time t for each clipped region. The tracking reliability is calculated, for example, based on the degree of similarity in template matching, consistency with past tracking history, a rate of change of a tracking box, and the like. The tracking reliability Sₜ ⁽ⁿ⁾ may also be calculated as a weighted linear sum of values thar evaluate these factors. The clip history data Hₜ is data that records a history, at the time t, of a clip size corresponding to a scale change in a tracked object. The clip history data Hₜ is used to determine the optimal scale for the next frame. The crossing determination data Dt is data that indicates whether a plurality of subjects cross each other within a frame at each time t.

The integrated tracking data 50 is data that is used to integrate tracking results that are obtained at each scale at the time t, and to determine a final tracking result.

The integrated tracking data 50 includes final position information for a tracked object (for example, final bounding-box coordinates for the tracked object), a final reliability score (final reliability of a tracking result), clipping range selection information, and a crossing detection flag.

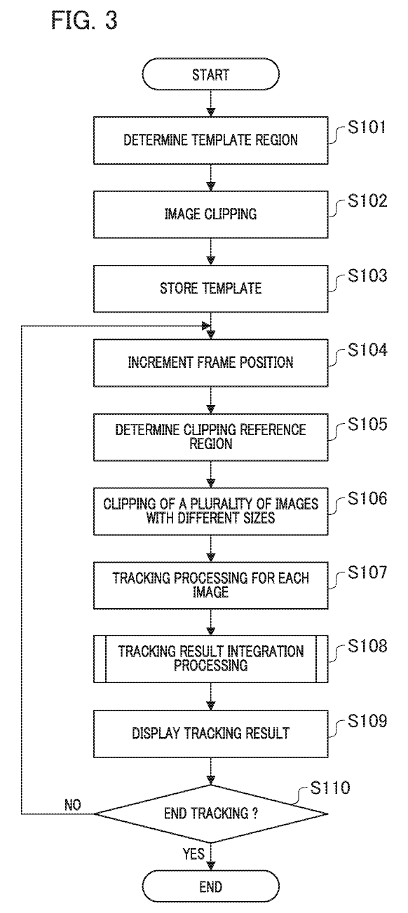

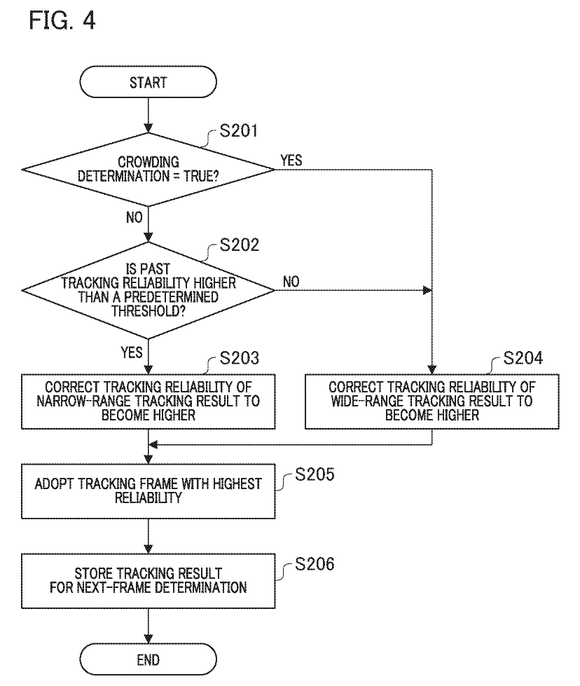

Next, tracking processing for a subject performed by the image tracking apparatus according to the first embodiment will be explained with reference to FIGS. 3 and 4. FIG. 3 is a flowchart illustrating the overall tracking processing for a subject that is performed by the image tracking apparatus according to the first embodiment. FIG. 4 is a flowchart illustrating the details of the tracking result integration processing.

First, the clipping reference region determination unit 110 of the image tracking apparatus determines a region to be used as a tracking template (S101). Here, a region selected by a user is assumed to be determined as the template region.

Next, the image clipping unit 111 clips the region that was determined to be a template in step S101 (S102).

Next, the template storage unit 120 stores the template information (S103).

Next, the clipping reference region determination unit 110 increments the frame position at which clipping is to be performed (S104).

Next, the clipping reference region determination unit 110 determines a clipping reference region for the image at the updated frame position (S105).

Next, with the clipping reference region determined in step S105 as the center, the image clipping unit 111 clips a plurality of images in different sizes (S106).

Next, the tracking unit 130 performs tracking processing for each of the plurality of images that was clipped in step S106 (S107). It is assumed that the tracking unit outputs, for each clipped image, candidate regions having a high correlation with a template that is stored in the template storage unit 120, together with a reliability thereof. The reliability can be evaluated, for example, by taking a sum of distances for respective pixels, or by comparing image feature quantities of a specific subject and increasing the reliability when the feature quantities are close to each other. Here, since tracking processing is performed independently for each clipped image, the same region may be output as a tracking candidate by a plurality of tracking processes. Additionally, there may be a case in which a region that is output as a tracking candidate for a clipped image of a certain size is not output as a tracking candidate for a clipped image of another size.

Image clipping is performed at different sizes for the following reasons.

Clipping in a narrow range aims to suppress erroneous tracking of similar persons or objects in the surroundings, or of a background, by limiting a tracking search range to a narrow region. In contrast, clipping in a wide range aims to find a tracked object in a case in which the tracked object has moved outside of the narrow-range clipped region due to high-speed movement of the subject or temporary loss of the subject. In addition, the purpose is to detect, in advance, a person or an object other than the tracked object that is present in the surroundings, prior to its crossing the tracked object. As described above, clipping in a narrow range and clipping in a wide range have a trade-off relationship, each having advantages and disadvantages. Therefore, by appropriately integrating results from both, tracking can be performed with higher accuracy than when clipping is performed using only one of the clipping sizes.

Since the clipping in step S107 is performed at a plurality of sizes, the clipping may be performed in two types, namely a narrow range and a wide range, or the clipping may also be performed in three types by additionally including an intermediate-size range between the narrow range and the wide range, or the clipping may also be performed in four or more types by further finely dividing the sizes.

Next, the tracking result integration unit 140 performs tracking result integration processing to integrate the plurality of tracking results that were obtained in step S107 (S108). Details of the tracking result integration processing will be explained below with reference to FIG. 4.

Next, the result display unit 150 displays a tracking result that was obtained in step S107 on a display device connected thereto (S109).

Next, the image tracking apparatus 100 determines whether or not to end the tracking processing (S110); in a case in which tracking of the subject will be continued (S110: NO), the processing returns to step S104, and in a case in which tracking of the subject will not be continued (S110: YES), the entire processing ends. Whether tracking processing is to be ended or continued may be determined based on separately defined conditions. For example, in a case in which the tracking function is applied to an autofocus function of a camera, the start and end of tracking may be determined according to an operation of a user, such as whether or not the user half-presses a shutter button.

Next, the details of the tracking result integration processing will be explained with reference to FIG. 4. This is processing corresponds to step S108 in FIG. 3.

First, the tracking result integration unit 140 performs subject crowding determination (S201). For example, in a case in which, within a certain past period, there is a frame in which a person other than the tracked object is detected at a position very close to the tracked object, it is determined that people are in a crowded state near the tracked object and the crowding flag is set to TRUE. In a case in which the crowding determination is TRUE (S201: YES), the process proceeds to step S204. A crowding determination being TRUE suggests that, in the current frame, the tracking object may be crossing another object, or that the frame corresponds to a timing immediately before or after the tracking object crosses another object. In a case where the tracked object is temporarily occluded by another person due to crossing, the tracked object may reappear, after the crossing, at a location that is distant from its position prior to the crossing. It is considered that, after such crossing, a reappearing tracked object is more likely to be captured by relying on a wide range tracking result rather than a narrow range tracking result. Therefore, when the crowding determination is TRUE, the tracking result integration unit 140 corrects the reliability of the wide range tracking results so as to be higher (S204). That is, a predetermined reliability is added to the tracking result reliability that was evaluated during the tracking processing (the same applies to the tracking result reliability, which will be described below). For example, in the tracking processing of step S106, a means for simultaneously tracking a plurality of people, such as multi-object tracking, may be used. In such a case, since a wide range tracking result becomes more reliable for a crossing scene than a narrow-range tracking result, the reliability of the wide range tracking result may be corrected so as to become an even higher value.

In contrast, in a case in which the crowding determination is not TRUE (S201: NO), the process proceeds to step S202. In a case in which the crowding determination is not TRUE, it is determined whether or not the tracking reliability in a past frame is higher than a predetermined threshold (S202). The tracking reliability in a past frame may be compared with the reliability value for a tracking processing result for an immediately preceding frame, or may be compared with an arithmetic mean value of reliability values of tracking processing results for a predetermined number of past frames.

It should be noted that, as another method, the determination in step S202 may be made such that, if the tracking reliability is low in a previous frame and there is no narrow-range tracking candidate frame having a reliability that is equal to or higher than a predetermined reliability in the current frame, the process proceeds to step S204.

In a case in which the tracking reliability in the past frame is higher than (equal to or greater than) the predetermined threshold (S202: YES), the process proceeds to step S203.

In a case in which the tracking reliability in a previous frame is higher than a predetermined threshold, the reliability of a narrow-range tracking result is corrected so as to become a higher value (S203). For example, in a case in which the tracking reliability in the immediately preceding frame is high, there is a high possibility that the subject is being correctly tracked. Accordingly, unless a subject moves at an extremely high speed, there is a high possibility that the subject will be present at a position that is close to the position in a previous frame, that is, within the narrow-range clipping region. In tracking results obtained through wide range tracking, there is a possibility that, due to the wide search region, similar objects or a background in the surroundings may be erroneously recognized as the tracked object. Therefore, if there is a high possibility that a subject is present within a narrow range, it is preferable to use the tracking result that has been obtained through narrow-range tracking. Accordingly, in step S203, the reliability of the narrow-range tracking result is corrected so as to become higher.

On the other hand, in a case in which the tracking reliability in a past frame is lower than a predetermined threshold (S202: NO), the process proceeds to step S204. In a case in which the tracking reliability in the past frame is low, the reliability of the wide range tracking result is corrected so as to become higher (S204).

For example, a low tracking reliability in the previous frame indicates a possibility that the subject has been lost or that erroneous tracking is being performed. To correctly recapture the subject, it is preferable to adopt a wide range tracking result when a more reliable tracking candidate can be obtained through wide range tracking, rather than continuing to rely on a narrow-range tracking result. Accordingly, in step S204, the reliability of the wide range tracking result is corrected to be higher.

Next, using the corrected tracking reliability in step S203 and S204, a region including a tracking candidate having the highest reliability among all tracking candidates is adopted as a tracking frame (S205).

Finally, for determination in the next and subsequent frames, each tracking result in the current frame is stored in a storage region (S206).

In the flowchart of FIG. 4, correction of tracking-result reliability is described for two clipping sizes, namely a narrow range and a wide range. However, in a case in which clipping is performed for more than two ranges, adjustment may be made by correcting the reliability in a stepwise manner such that the reliability is increased as the clipping range becomes narrower, and such that the reliability is increased as the clipping range becomes wider.

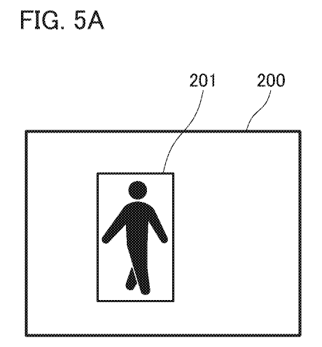

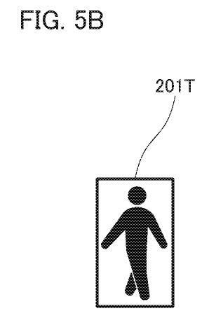

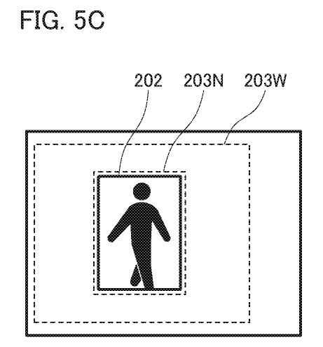

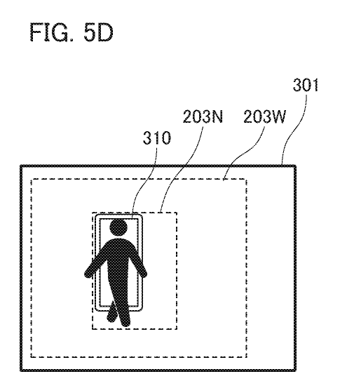

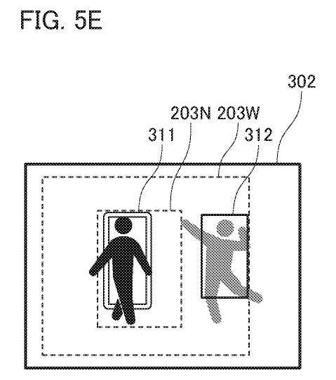

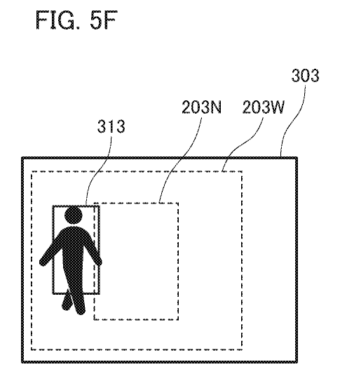

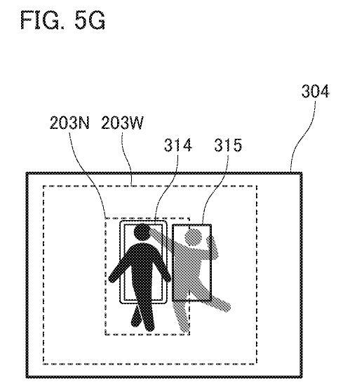

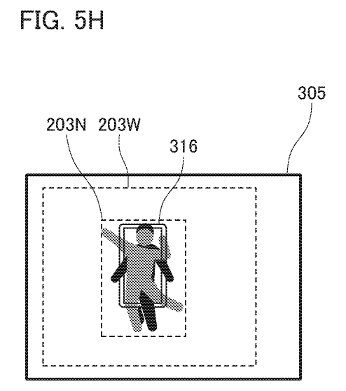

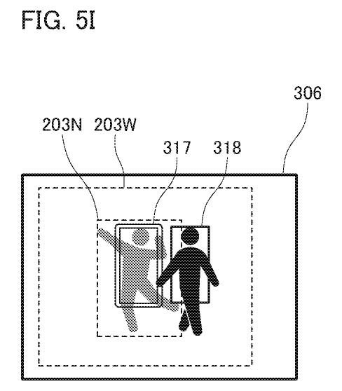

Next, the explanation of the processing will be supplemented using specific images related to tracking with reference to FIGS. 5A to 5I. FIGS. 5A to 5I are diagrams explaining images related to tracking.

First, specific examples of images from template creation to clipping of a plurality of images of different sizes will be explained with reference to FIGS. 5A to 5C.

In the present embodiment, it is assumed that an initial frame image 200 as shown in FIG. 5A is provided.

In step S102, the image clipping unit 111 clips the region that was determined in step S101 from the initial frame image 200 of FIG. 5A. Then, in step S103, the template storage unit 120 stores information for the clipped region 201 as a template 201T, as shown in FIG. 5B.

It is assumed that, in step S105, the clipping reference region determination unit 110 determines a clipping reference region 202, as shown in FIG. 5C. At this time, in step S106, the image clipping unit 111 performs clipping of a plurality of images with different sizes centered on the clipping reference region 202. Here, it is assumed that clipping is performed in two sizes, namely, a narrow-range clipping region 203N and a wide range clipping region 203W, as shown in FIG. 5C.

Next, specific examples of images related to tracking result integration processing will be explained with reference to FIG. 5C to FIG. 5I.

In FIGS. 5D to 5I, dotted lines indicate narrow-range and wide range clipping ranges, a single line surrounding a person indicates a tracking candidate frame that has been output from either narrow-range tracking processing or wide range tracking processing, and a double line surrounding a person indicates a tracking candidate frame that has been output from both the narrow-range tracking processing and the wide range tracking processing.

In the determination in step S202, it is assumed that a frame image 300 in FIG. 5C is a previous frame, a frame image 301 in FIG. 5D is the current frame, and that the tracking reliability for the previous frame is high. In this case, the process proceeds to step S203. Since the tracking reliability for the previous frame is high, there is a high possibility that in the current frame, the tracked object will be located at a position that is not far from its previous position, and it is therefore sufficient to rely on the narrow-range tracking result. Therefore, a tracking candidate frame 310 that surrounds the tracked object shown in FIG. 5D can be selected.

Additionally, in the determination of step S202, it is assumed that the frame image 301 in FIG. 5D is the previous frame, the frame image 302 in FIG. 5E is the current frame, and that the tracking reliability of the previous frame is high. In this case as well, the process proceeds to step S203. In FIG. 5E, within a tracking candidate frame 312, another person is present at a position that is distant from the tracked object, and the wide range tracking result outputs this person as a tracking candidate. However, as was described above, a high tracking reliability in a previous frame indicates a high possibility that in the current frame, the tracked object will be present at a position that is close to a previous position of the tracked object, and thus, it is sufficient to rely on a narrow-range tracking result. Therefore, the possibility of erroneously selecting a tracking candidate frame 312 for another person can be reduced. Accordingly, the tracking candidate frame 311 surrounding the tracked object can be selected.

In contrast, in the determination of step S202, it is assumed that the frame image 301 in FIG. 5D is the previous frame, the frame image 302 in FIG. 5F is the current frame, and the tracking reliability in the previous frame is low. In this case, the process proceeds to step S204. In FIG. 5F, a tracking candidate frame 313 that includes the tracked object has moved out of the narrow-range clipping region 203N. This can occur in a case in which the tracked object is lost in the previous frame, that is, in a case in which the tracking reliability is low. Therefore, in a case in which the tracking reliability for the previous frame is low, it is preferable to increase the reliability of the wide range tracking result, whereby the tracking candidate frame 313 surrounding the tracked object can be selected.

Additionally, it is assumed that the frame image 304 that is shown in FIG. 5G is a frame from two frames earlier, that the frame image 305 that is shown in FIG. 5H is the previous frame, and that the frame image 306 that is shown in FIG. 5I is the current frame. In FIG. 5G, in tracking processing using the narrow-range clipping region 203N, another person (the subject in a tracking candidate frame 315) that is positioned near a tracking candidate frame 314 that includes the tracking object cannot be detected. In contrast, in tracking processing using the wide range clipping region 203W, this other person can be detected. Accordingly, a crowding determination becomes possible, and since the crowding determination becomes TRUE in step S201, the process proceeds to step S204.

Additionally, in the frame image 306 that is shown in FIG. 5I, the crossing between people has concluded, and the tracked object has reappeared. However, since the tracking object has moved out of the narrow-range clipping region 203N, the reappeared tracking object cannot be detected in tracking processing using the narrow-range clipping region 203N. On the other hand, since tracking processing using the wide range clipping region 203W can capture the reappeared tracked object, the tracked object can be output by a tracking candidate frame 318. As was discussed above, during periods of crowding, people may cross paths, and once the crowd disperses, the tracked object may reappear at a distant location. Accordingly, it is preferable to increase the reliability of the wide range tracking result. As a result, the possibility of continuously and erroneously selecting the tracking candidate frame 317 corresponding to another person can be reduced, and the tracking candidate frame 318 that surrounds the tracked object can be selected.

As described above, according to the image tracking apparatus of the present embodiment, when performing matching with a template of the tracked object, erroneous tracking of a similar person or a background in the surroundings can be prevented by executing the matching processing using an image that was obtained through narrow-range clipping. On the other hand, by performing matching processing using an image that was obtained through wide range clipping, it becomes possible to capture the tracked object in a case in which the tracked object is lost within the narrow range, and to recognize, in advance, the presence of a person approaching the tracked object. By combining both results, high-precision tracking becomes possible, thereby improving tracking performance.

### Second Embodiment

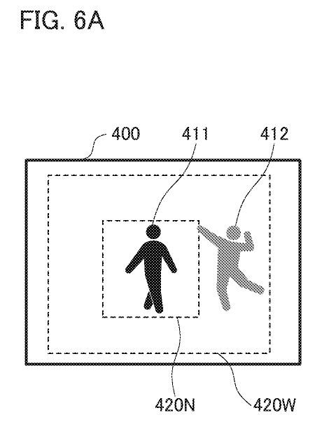

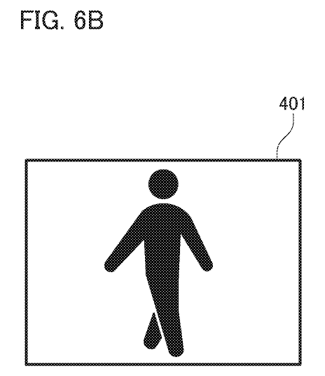

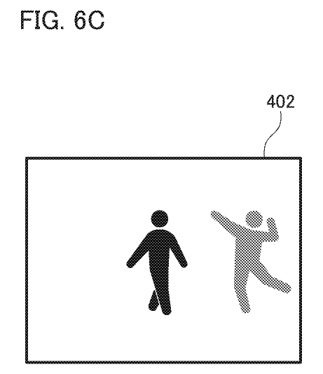

A second embodiment according to the present disclosure will be explained below with reference to FIGS. 6A to 8. In the first embodiment, a clipped image is directly used as an input image for tracking processing. However, depending on the tracking means, it may be expected that an image of a predetermined size will be used as the input for tracking. For example, in the case of a tracking means using a CNN, if an image of the size assumed during learning is not provided as input, the expected results may not be obtained in terms of operation or performance. In such a case, after the image is clipped, it is necessary to resize the input image to an expected size so as to be compatible with the tracking processing. However, in some cases, resizing the input image may adversely affect the performance of tracking.

Images corresponding to this situation will be explained below with reference to FIGS. 6A to 6C. FIGS. 6A to 6C are diagrams for explaining the influence of image resizing. It is assumed that a frame image 400 shown in FIG. 6A is input, this image is clipped using a narrow-range clipping region 420N and a wide range clipping region 420W, then resized such that each clipped image has a default size, and an image 401 that is shown in FIG. 6B and an image 402 that is shown in FIG. 6C are thereby obtained.

It can be seen that the scale of the tracking object 411 within the image has changed due to resizing. In a case in which a template is generated using the image 401 that is shown in FIG. 6B, and tracking processing is performed using the image 402 that is shown in FIG. 6C as an input image, there is a possibility that a tracking result cannot be correctly output because the scale of the tracked object is different.

In the present embodiment, in order to solve such a drawback, a plurality of templates corresponding to different types of clipping ranges are stored, allowing the effects of the present disclosure to be maintained even in a case in which resizing is performed after clipping. In the present embodiment, the explanation will focus on the differences from the image tracking apparatus of the first embodiment.

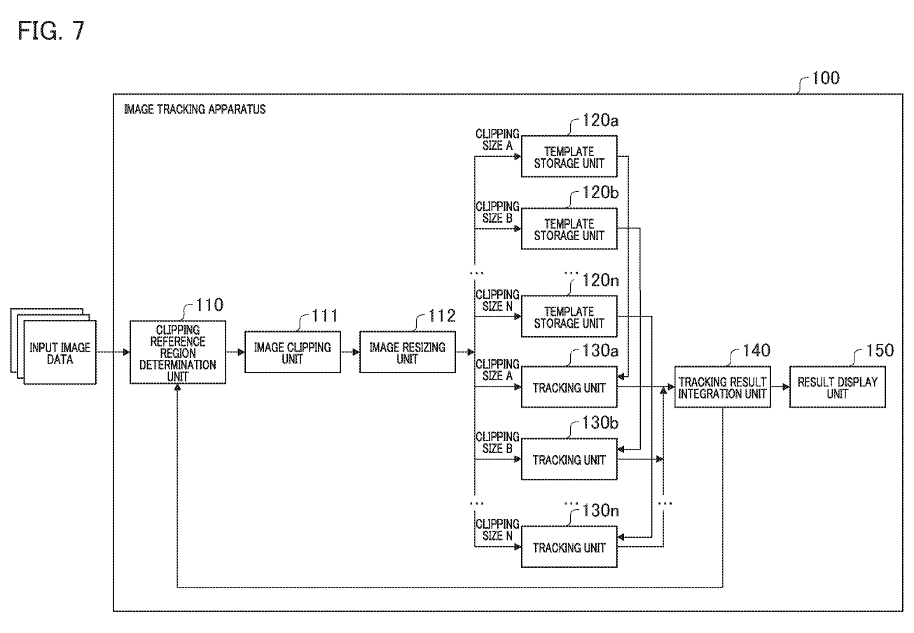

First, the configuration of an image tracking apparatus according to a second embodiment will be explained with reference to FIG. 7. FIG. 7 is a functional configuration diagram of the image tracking apparatus according to the second embodiment.

The image tracking apparatus 100 in the present embodiment differs from the functional configuration of the first embodiment shown in FIG. 2 in that it includes an additional image resizing unit 112 and a plurality of template storage units 120 (denoted as 120a to 120n in the figure).

The image resizing unit 112 is a functional unit that resizes an image that has been clipped by the image clipping unit 111 to a default size. Each of the template storage units 120a to 120n store a plurality of templates for use in the tracking processing that is performed by the corresponding tracking units 130a to 130n. Although in the first embodiment, the template storage unit stores only one type of template, in the present embodiment, the template storage unit stores a plurality of templates that have been generated from a plurality of clipped images. For example, in a case in which there are N types of images that have been clipped by the image clipping unit 111, the template storage units store N types of templates corresponding thereto. At this time, in a case in which there is a constraint on the storage region, the number of template types may be fewer than N types, whereas in a case in which there is sufficient storage capacity, more than N types of templates may be stored.

The tracking units 130a to 130n perform tracking processing on each image that has been generated by the image resizing unit 112 by selecting a template that has been generated from an image with a clipping size that is the same as the clipping size of the image, and a template that has been generated from n image with a clipping size that is closest to the clipping size of the image. Although the scale of the tracked object changes due to resizing, appropriate templates corresponding to each scale are stored in advance, allowing for the selection of a suitable template during tracking. That is, tracking processing can be performed without being affected by changes in scale.

Next, a data structure used in the image tracking apparatus according to the present embodiment will be explained. Although in the first embodiment, the tracking analysis data 40 includes only a single piece of template data T₀, the present embodiment differs in that it includes a plurality of template data T₀ ⁽ⁿ⁾.

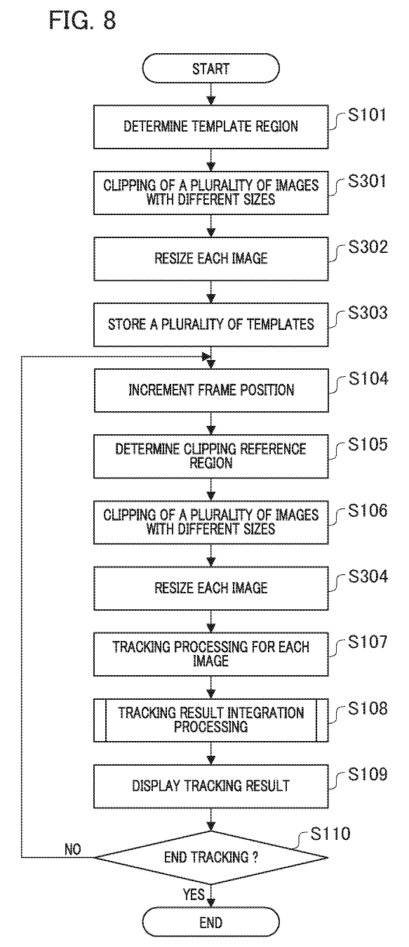

Next, tracking processing for a subject performed by the image tracking apparatus according to the second embodiment will be explained with reference to FIG. 8. FIG. 8 is a flowchart illustrating the overall tracking processing for a subject that is performed by the image tracking apparatus according to the second embodiment.

The tracking processing in the present embodiment differs from that of the first embodiment that is shown in FIG. 3 in that the steps S102 and S103 are replaced with steps S301 to S303, and an additional step S304 is inserted after the step S106.

After the template region is determined, the image clipping unit 111 clips a plurality of images of different sizes for the template (S301).

Next, the image resizing unit 112 performs resizing of the images that were clipped in step S301 (S302).

Then, the template storage unit 120 stores information for a plurality of templates (S303).

After the plurality of images is clipped in different sizes in step S106, the image resizing unit 112 performs resizing on the images (S304).

Subsequently, the tracking unit 130 performs tracking processing for each of the resized images (S107). As previously explained, the tracking unit 130 selects a template generated from an image with a clipping size that is the same as the clipping size of the input image, and a template generated from an image with a clipping size that is the closest to the clipping size of the input image, and performs tracking processing.

As described above, according to the image tracking apparatus of the present embodiment, even in a configuration requiring resizing after image clipping, tracking accuracy can be improved by using tracking results that have been obtained from a plurality of types of clipped images.

### Third Embodiment

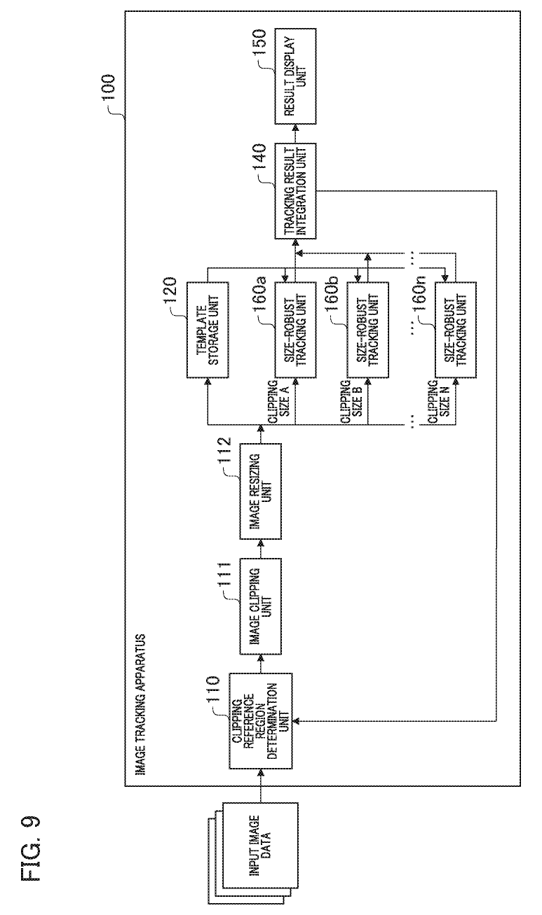

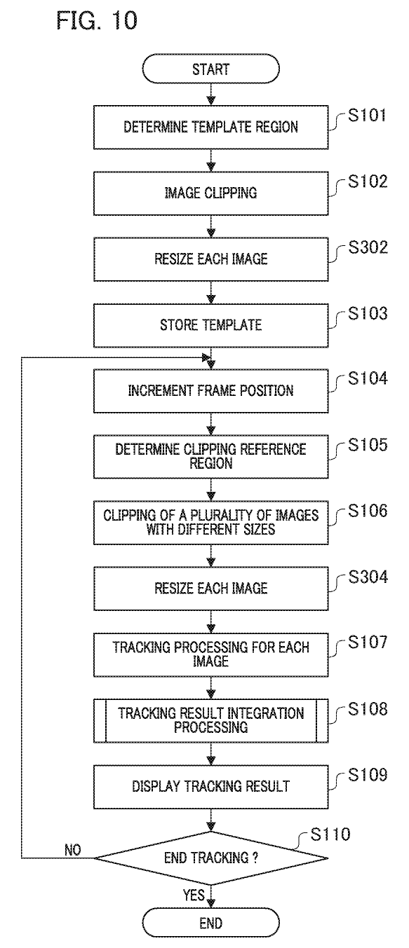

A third embodiment according to the present disclosure will be explained below with reference to FIGS. 9 and 10. In the second embodiment, a means has been explained for achieving the effects of the present disclosure even in a configuration in which resizing is required after image clipping, by storing a plurality of templates. In the present embodiment, similarly, a means is explained in which, even in a configuration in which resizing is required after image clipping, the effects of the present disclosure are achieved by storing only one type of template.

In the present embodiment, as the tracking means, a machine learning model is used that has been pre-trained to recognize a tracked object despite scale differences between the template and the input image. For example, the machine learning model is configured to receive a template and a tracking image as inputs, and to output the region within the tracking image that shows the highest correlation with the template. At this time, data in which the scale of the tracked object differs between the template and the tracking image is input, and the model is trained to recognize that the tracked objects in both represent the same person. Accordingly, it is possible to generate a learning model with a high robustness with respect to size, and that can recognize the tracked object even in a case in which the scale of the tracked object differs between the template and the tracking image. However, it should be noted that this may also increase the risk of erroneously recognizing a different person with a different scale as the tracked object. Thus, employing a tracking means with a high robustness with respect to size enables tracking in images of a plurality of clipping sizes, even in a case in which only one type of template is stored.

First, the configuration of the image tracking apparatus according to the third embodiment will be explained with reference to FIG. 9. FIG. 9 is a functional configuration diagram of the image tracking apparatus according to the third embodiment.

In the image tracking apparatus 100 according to the present embodiment, the image resizing unit 112 is added to the configuration of the image tracking apparatus 100 shown in FIG. 2, and the tracking unit 130 is replaced with size-robust tracking units 160 (denoted as 160a to 160n in the figure) which utilize the machine learning model that was explained above.

Next, tracking processing for a subject performed by the image tracking apparatus according to the third embodiment will be explained with reference to FIG. 10. FIG. 10 is a flowchart illustrating the overall tracking processing for a subject performed by the image tracking apparatus according to the third embodiment.

In the present embodiment, the tracking processing is based on the tracking processing in the first embodiment that is shown in FIG. 3, with the addition of image resizing steps S302 and S303. The processing of the image resizing steps S302 and S303 is similar to the steps that were explained in the second embodiment.

Additionally, the processing of step S107 of the first embodiment is replaced with size-robust tracking processing (S107a), which utilizes the machine learning model.

As was described above, according to the image tracking apparatus of the present embodiment, size-robust tracking processing, which utilizes the machine learning model, is executed. Thus, even in a configuration that requires resizing after image clipping, tracking accuracy can be improved by using tracking results that have been obtained from a plurality of clipped images while using a single template.

### Fourth Embodiment

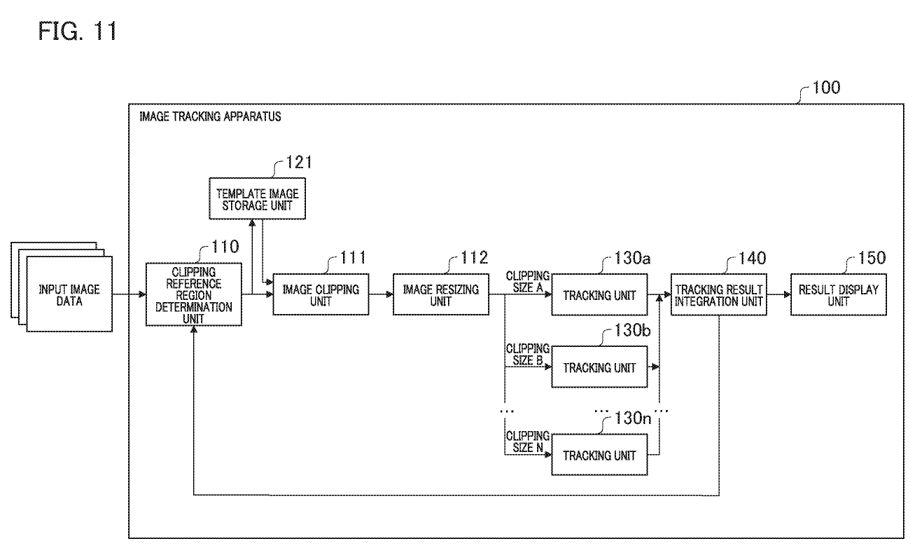

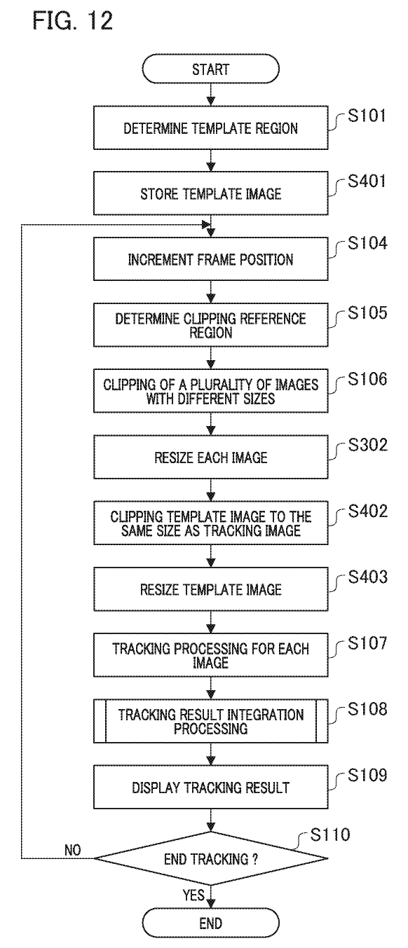

A fourth embodiment according to the present disclosure will be explained below with reference to FIGS. 11 and 12.

In the third embodiment, a configuration is explained in which, by using tracking means with a robust size, the effects of the present disclosure are exhibited even in a configuration in which resizing is required after image clipping. In the present embodiment, similarly, a means is explained in which, in a configuration requiring resizing after image clipping, the effects of the present disclosure are achieved by storing the image itself instead of a template.

First, a configuration of the image tracking apparatus according to the fourth embodiment will be explained with reference to FIG. 11. FIG. 11 is a functional configuration diagram of the image tracking apparatus according to the fourth embodiment.

The image tracking apparatus 100 according to the present embodiment differs from the configuration of the image tracking apparatus 100 that is shown in FIG. 2 in that a template image storage unit 121 is added in place of the template storage unit 120.

In the present embodiment, instead of storing a template, image data used for template generation is directly stored in a storage region. Each time the tracking unit 130 performs tracking processing, a template is generated from the template image storage unit 121 and input to the tracking unit 130 via the image clipping unit 111. At that time, processing that is identical to the clipping and resizing processing that is performed on the tracking image is also performed on the template image. As a result, the scale of the tracking object in the template and in the tracking image is always matched. Accordingly, tracking can be performed at the same scale. However, in the present embodiment, it should be noted that processing time is required for template image clipping, resizing, and template information generation processing each time tracking is performed.

Next, tracking processing for a subject performed by the image tracking apparatus according to the fourth embodiment will be explained with reference to FIG. 12. FIG. 12 is a flowchart illustrating the overall tracking processing for a subject performed by the image tracking apparatus according to the fourth embodiment.

The tracking processing of the present embodiment differs from the tracking processing of the third embodiment that is shown in FIG. 10 in that the steps S102, S302, and S103 are omitted, and the steps S401, S402, and S403 are added, step S401 being a step for storing a template image, step S402 being a step for clipping the template image, and step S403 being a step for resizing the template image.

After the template region determination in step S101, the template image storage unit 121 stores, image data as is to be used as a template in a storage region (S401).

After image resizing in step S302, the image clipping unit 111 reads out a template image from the template image storage unit 121 and clips the template image to the same size as the tracking image (S402).

Next, the image resizing unit 112 resizes the image that was clipped in step S402 to a default size (S403). Then, using the tracking image that was resized in step S302, and the template that was obtained from the image resized in step S403, the tracking unit 130 performs tracking (S106).

As was described above, according to the configuration of the image tracking apparatus of the present embodiment, each time tracking processing is performed, image clipping and resizing are performed on image data that is used as a template. Accordingly, even in a configuration requiring resizing after image clipping, tracking accuracy can be improved by using tracking results that have been obtained from a plurality of types of clipped images.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-70438, filed on Apr. 22, 2025, which is hereby incorporated by reference herein in its entirety.

What is claimed is:

1. An image tracking apparatus that acquires time-series continuous input images and tracks a subject in the images, the image tracking apparatus comprising:
at least one memory storing instructions; and
at least one processor executing the stored instructions causing the image tracking apparatus to:
determine a clipping reference region from an image;
clip, from the image, a plurality of images of regions, each region having a different size, and including the clipping reference region determined;
perform tracking processing for a subject in each of the images clipped based on features of the subject; and
calculate tracking reliability for a plurality of output tracking results, and integrate tracking results corresponding to images of different clipping regions based on the tracking reliability.

2. The image tracking apparatus according to claim 1, wherein tracking processing is performed by acquiring a tracking template for a clipped image, and matching features of the template with features of the subject.

3. The image tracking apparatus according to claim 1,
wherein it is determined whether or not a subject in an image is in a crowded state,
wherein, in a case in which it is determined that the subject is in the crowded state, a reliability of tracking results corresponding to images that have been clipped in a wider size range is corrected so as to become higher, and
wherein, in a case in which it is determined that the subject is not in the crowded state, a reliability of tracking results corresponding to images that have been clipped in a narrower size range is corrected so as to become higher.

4. The image tracking apparatus according to claim 1,
wherein tracking reliability for tracking results of images of past frames is determined,
wherein, in a case in which the tracking reliability is less than a predetermined threshold, a reliability of tracking results corresponding to images that have been clipped in a wider size range is corrected so as to become higher, and
wherein, in a case in which the tracking reliability is equal to or greater than the predetermined threshold, a reliability of tracking results corresponding to images that have been clipped in a narrower size range is corrected so as to become higher.

5. The image tracking apparatus according to claim 1, wherein a region that includes a tracking candidate having the highest tracking reliability is set as a tracking frame and used as an input for image clipping of a next frame.

6. The image tracking apparatus according to claim 2,
wherein the image tracking apparatus performs resizing processing on a clipped image, and performs tracking processing by acquiring tracking templates respectively corresponding to a plurality of generated images and matching features of the tracking templates with features of subjects in images having different sizes.

7. The image tracking apparatus according to claim 2,
wherein the image tracking apparatus performs resizing processing on a clipped image and acquires a tracking template for the clipped image, and
wherein the image tracking apparatus performs tracking processing for a subject by recognizing a tracking object even in a case in which a scale of the tracking object differs from a scale of the tracking template.

8. The image tracking apparatus according to claim 2, wherein the image tracking apparatus performs resizing processing on the clipped image, stores an image to be used for a template, and generates a template from the stored image each time tracking processing is performed.

9. An image tracking method performed by an image tracking apparatus that acquires time-series continuous input images and tracks a subject in the images, the image tracking method comprising:
determining, by the image tracking apparatus, a clipping reference region from an image;
clipping, by the image tracking apparatus, a plurality of images of regions, each having a different size from the image, and each including a clipping reference region that has been determined;
performing, by the image tracking apparatus, tracking processing for a subject in each clipped image based on a feature of the subject; and
integrating, by the image tracking apparatus, a plurality of tracking results output based on reliability, wherein the tracking results correspond to images of different clipping regions.

10. A non-transitory computer-readable storage medium configured to store a computer program comprising instructions for executing the functions of the following units:
at least one processor or circuit executing the steps described in claim 9.
